(19) United States
(12) Patent Application Publication
(10) Pub. No.: US 2014/0208794 A1
(43) Pub. Date: Jul. 31, 2014

(54) THERMAL ENERGY EXCHANGER WITH HEAT PIPE

(71) Applicant: VISTEON GLOBAL TECHNOLOGIES, INC., Van Buren Twp., MI (US)

(72) Inventor: Lakhi Nandlal Goenka, Ann Arbor, MI (US)

(73) Assignee: VISTEON GLOBAL TECHNOLOGIES, INC., Van Buren Twp., MI (US)

(21) Appl. No.: 13/754,121

(22) Filed: Jan. 30, 2013

(51) Int. Cl. B60H 1/00

(52) U.S. Cl. CPC B60H 1/00021
USPC 62/404

(57) ABSTRACT

A control module for a heating, ventilating, and air conditioning system includes a housing having an air flow conduit formed therein. An evaporator core is disposed in the air flow conduit, wherein at least a portion of the evaporator is configured to receive a first fluid from a first fluid source therein. An internal thermal energy exchanger is disposed in the air flow conduit downstream of at least a portion of the evaporator core and upstream of a blend door disposed in the air flow conduit. The internal thermal energy exchanger is in thermal energy exchange relationship with a second fluid source through a heat pipe.

### FIELD OF THE INVENTION

The invention relates to a climate control system for a vehicle and more particularly to a heating, ventilating, and air conditioning system of a vehicle having a thermal energy exchanger disposed therein.

### BACKGROUND OF THE INVENTION

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilating and air conditioning (HVAC) system. The HVAC system conditions air flowing therethrough and distributes the conditioned air throughout the passenger compartment.

Typically, a compressor of a refrigeration system provides a flow of a fluid having a desired temperature to an evaporator disposed in the HVAC system to condition the air. The compressor is generally driven by a fuel-powered engine of the vehicle. However, in recent years, vehicles having improved fuel economy over the fuel-powered engine and other vehicles are quickly becoming more popular as a cost of traditional fuel increases. The improved fuel economy is due to known technologies such as regenerative braking, electric motor assist, and engine-off operation. Although the technologies improve fuel economy, accessories powered by the fuel-powered engine no longer operate when the fuel-powered engine is not in operation. One major accessory that does not operate is the compressor of the refrigeration system. Therefore, without the use of the compressor, the evaporator disposed in the HVAC system does not condition the air flowing therethrough and the temperature of the passenger compartment increases to a point above a desired temperature.

Accordingly, vehicle manufacturers have used a thermal energy exchanger disposed in the HVAC system to condition the air flowing therethrough when the fuel-powered engine is not in operation. One such thermal energy exchanger, also referred to as a cold accumulator, is described in U.S. Pat. No. 6,854,513 entitled VEHICLE AIR CONDITIONING SYSTEM WITH COLD ACCUMULATOR, hereby incorporated herein by reference in its entirety. The cold accumulator includes a phase change material, also referred to as a cold accumulating material, disposed therein. The cold accumulating material absorbs heat from the air when the fuel-powered engine is not in operation. The cold accumulating material is then recharged by the conditioned air flowing from the cooling heat exchanger when the fuel-powered engine is in operation.

In U.S. Pat. No. 6,691,527 entitled AIR-CONDITIONER FOR A MOTOR VEHICLE, hereby incorporated herein by reference in its entirety, a thermal energy exchanger is disclosed having a phase change material disposed therein. The phase change material of the thermal energy exchanger conditions a flow of air through the HVAC system when the fuel-powered engine of the vehicle is not in operation. The phase change material is charged by a flow of a fluid from the refrigeration system therethrough.

While the prior art HVAC systems perform adequately, it is desirable to produce a thermal energy exchanger for an HVAC system having a coolant circulating in at least a portion thereof, wherein an effectiveness and efficiency thereof are maximized.

### SUMMARY OF THE INVENTION

In concordance and agreement with the present invention, a thermal energy exchanger for an HVAC system having a coolant circulating in at least a portion thereof, wherein an effectiveness and efficiency thereof are maximized, has surprisingly been discovered.

In one embodiment, a heating, ventilating, and air conditioning (HVAC) system, comprises: a control module including housing having an air flow conduit formed therein; an evaporator core disposed in the air flow conduit, at least a portion of the evaporator core configured to receive a first fluid from a first fluid source therein; and a thermal energy exchanger disposed in the air flow conduit downstream of the at least a portion the evaporator core, the thermal energy exchanger in thermal energy exchange relationship with a second fluid source through a heat pipe.

In another embodiment, a heating, ventilating, and air conditioning (HVAC) system, comprises: a control module including housing having an air flow conduit formed therein; and an evaporator core having a plurality of layers disposed in the air flow conduit, wherein at least one of the layers is configured to receive a first fluid from a first fluid source therein and at least another one of the layers is in thermal energy exchange relationship with a second fluid source through a heat pipe, wherein the heat pipe is configured to receive a second fluid from the second fluid source therein.

In yet another embodiment, a heating, ventilating, and air conditioning (HVAC) system of a vehicle, comprises; a control module including a housing having an air flow conduit formed therein; an evaporator core disposed in the air flow conduit, at least a portion of the evaporator core configured to receive a first fluid from a first fluid source therein; a thermal energy exchanger disposed in the air flow conduit downstream of the at least a portion the evaporator core, the thermal energy exchanger in fluid communication with a second fluid source through a heat pipe configured to receive a second fluid from the second fluid source therein; and a heater core disposed in the air flow conduit downstream of the thermal energy exchanger, the heater core in fluid communication with a third fluid source.

### BRIEF DESCRIPTION OF THE DRAWINGS

The above, as well as other objects and advantages of the invention, will become readily apparent to those skilled in the art from reading the following detailed description of various embodiments of the invention when considered in the light of the accompanying drawings in which:

FIG. 1 is a schematic flow diagram of an HVAC system including a fragmentary sectional view of an HVAC module having an evaporator core disposed therein according to an embodiment of the invention and showing a portion of the evaporator core in fluid communication with a first fluid source and another portion of the evaporator core in thermal energy exchange relationship with a second fluid source via a heat pipe;

FIG. 2 is a schematic perspective view of the evaporator core illustrated in FIG. 1 showing a portion of two layers of the evaporator core cutaway;

FIG. 3 is a schematic flow diagram of an HVAC system including a fragmentary sectional view of an HVAC module having an evaporator core disposed therein according to an embodiment of the invention and showing a portion of the evaporator core in fluid communication with a first fluid source and another portion of the evaporator core in thermal energy exchange relationship with a second fluid source via a heat pipe, wherein the second fluid source is an external thermal energy exchanger in fluid communication with another vehicle system;

FIG. 4 is a schematic flow diagram of an HVAC system including a fragmentary sectional view of an HVAC module having an evaporator core disposed therein according to another embodiment of the invention and showing a portion of the evaporator core in fluid communication with a first fluid source and another portion of the evaporator core spaced apart from the portion of the evaporator core and in thermal energy exchange relationship with a second fluid source via a heat pipe;

FIG. 5 is a schematic flow diagram of an HVAC system including a fragmentary sectional view of an HVAC module having an evaporator core and an internal thermal energy exchanger disposed therein according to another embodiment of the invention and showing the evaporator core in fluid communication with a first fluid source and the internal thermal energy exchanger in thermal energy exchange relationship with a second fluid source via a heat pipe; and

FIG. 6 is a schematic flow diagram of an HVAC system including a fragmentary sectional view of an HVAC module having an evaporator core and an internal thermal energy exchanger disposed therein according to another embodiment of the invention and showing a portion of the evaporator core in fluid communication with a first fluid source and another portion of the evaporator core in thermal energy exchange relationship with a second fluid source via a heat pipe and a third fluid source.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

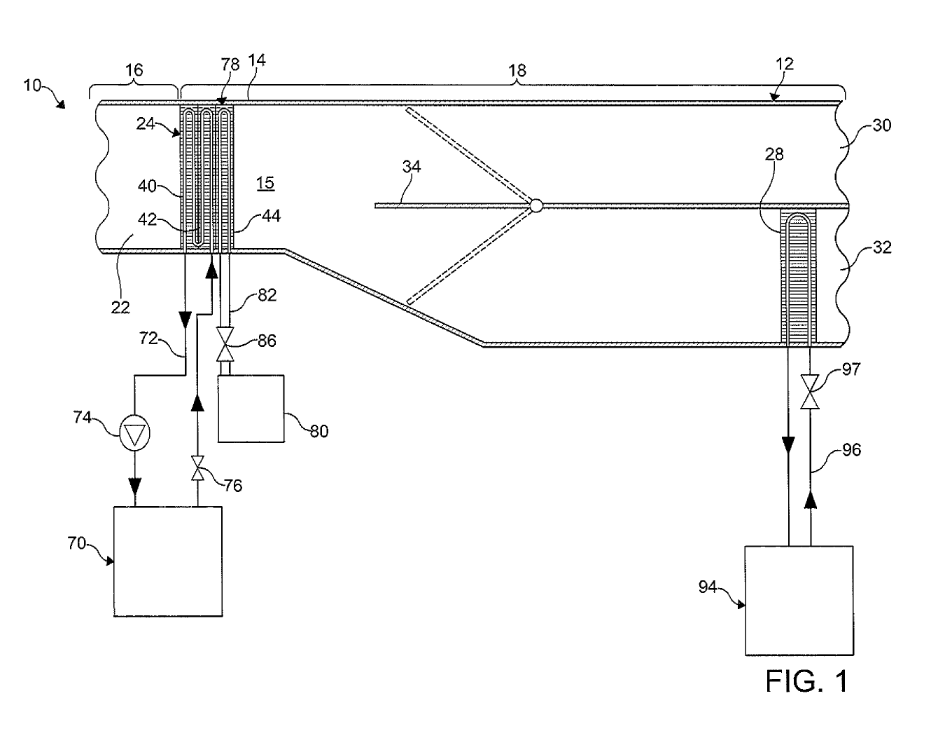

FIG. 1 shows a heating, ventilating, and air conditioning (HVAC) system 10 according to an embodiment of the invention. The HVAC system 10 typically provides heating, ventilation, and air conditioning for a passenger compartment of a vehicle (not shown). The HVAC system 10 includes a control module 12 to control at least a temperature of the passenger compartment.

The module 12 illustrated includes a hollow main housing 14 with an air flow conduit 15 formed therein. The housing 14 includes an inlet section 16, a mixing and conditioning section 18, and an outlet and distribution section (not shown). In the embodiment shown, an air inlet 22 is formed in the inlet section 16. The air inlet 22 is in fluid communication with a supply of air (not shown). The supply of air can be provided from outside of the vehicle, recirculated from the passenger compartment of the vehicle, or a mixture of the two, for example. The inlet section 16 is adapted to receive a blower wheel (not shown) therein to cause air to flow through the air inlet 22. A filter (not shown) can be provided upstream, in, or downstream of the inlet section 16 in respect of a direction of flow through the module 12 if desired.

The mixing and conditioning section 18 of the housing 14 is configured to receive an evaporator core 24 and a heater core 28 therein. As shown, at least a portion of the mixing and conditioning section 18 is divided into a first passage 30 and a second passage 32. In particular embodiments, the evaporator core 24 is disposed upstream of a selectively positionable blend door 34 in respect of the direction of flow through the module 12 and the heater core 28 is disposed in the second passage 32 downstream of the blend door 34 in respect of the direction of flow through the module 12. A filter (not shown) can also be provided upstream of the evaporator core 24 in respect of the direction of flow through the module 12, if desired.

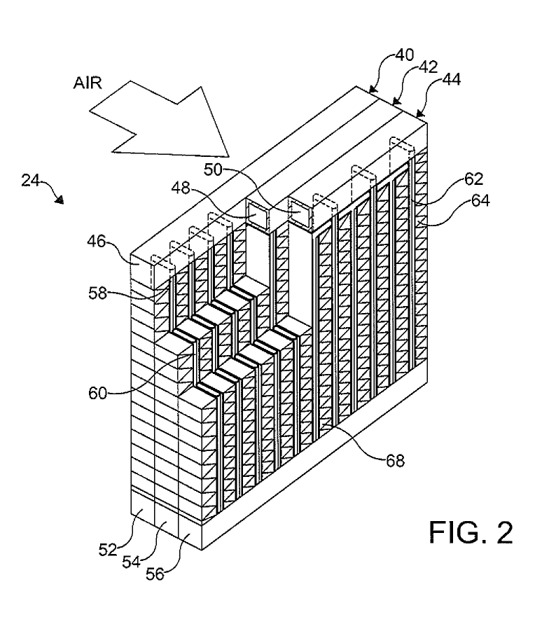

The evaporator core 24 of the present invention, shown in FIGS. 1-2, is a multi-layer louvered-fin thermal energy exchanger. In a non-limiting example, the evaporator core 24 has a first layer 40, a second layer 42, and a third layer 44 arranged substantially perpendicular to the direction of flow through the module 12. Additional or fewer layers than shown can be employed as desired. The layers 40, 42, 44 are arranged so the second layer 42 is disposed downstream of the first layer 40 and upstream of the third layer 44 in respect of the direction of flow through the module 12. It is understood, however, that the layers 40, 42, 44 can be arranged as desired. The layers 40, 42, 44 can be bonded together by any suitable method as desired such as brazing and welding, for example.

Each of the layers 40, 42, 44 of the evaporator core 24 includes an upper first fluid manifold 46, 48, 50 and a lower second fluid manifold 52, 54, 56, respectively. A plurality of first tubes 58 extends between the fluid manifolds 46, 52 of the first layer 40. A plurality of second tubes 60 extends between the fluid manifolds 48, 54 of the second layer 42. A plurality of third tubes 62 extends between the fluid manifolds 50, 56 of the third layer 44. In particular embodiments, each of the first upper fluid manifolds 46, 48, 50 is an inlet manifold which distributes the fluid into at least a portion of the respective tubes 58, 60, 62 and each of the second lower fluid manifolds 52, 54, 56 is an outlet manifold which collects the fluid from at least a portion of the respective tubes 58, 60, 62.

Each of the tubes 58, 60, 62 is provided with louvered fins 64 disposed therebetween. The fins 64 abut an outer surface of the tubes 58, 60, 62 for enhancing thermal energy transfer of the evaporator core 24. Each of the fins 64 defines an air space 68 extending between the tubes 58, 60, 62. The tubes 58, 60, 62 of the evaporator core 24 can further include a plurality of internal fins (not shown) formed on an inner surface thereof. The internal fins further enhance the transfer of thermal energy of the evaporator core 24. It is understood, however, that the evaporator core 24 can be constructed as a finless thermal energy exchanger if desired.

In a particular embodiment, the layers 40, 42 of the evaporator core 24, shown in FIG. 1, are in fluid communication with a first fluid source 70 via a conduit 72. The first fluid source 70 includes a prime mover 74 such as a compressor or a pump, for example, to cause a first fluid to circulate therein. Each of the layers 40, 42 is configured to receive a flow of the first fluid from the first fluid source 70 therein. The first fluid absorbs thermal energy to condition the air flowing through the HVAC module 12 when a fuel-powered engine of the vehicle, and thereby the prime mover 74, is in operation. As a non-limiting example, the first fluid source 70 is a refrigeration circuit, and the first fluid is a refrigerant such as R134a, HFO-1234yf, AC-5, AC-6, and CO₂, for example. A valve 76 can be disposed in the conduit 72 to selectively militate against the flow of the first fluid therethrough.

The HVAC system 10 includes an internal thermal energy exchanger 78 in thermal energy exchange relationship with a second fluid source 80. As illustrated, the internal thermal energy exchanger 78 is the layer 44 of the evaporator core 24. In other embodiments, the layers 40, 44 of the evaporator core 24 are in fluid communication with the first fluid source 70 and the internal thermal energy exchanger 78 is the layer 42 of the evaporator core 24 in thermal energy exchange relationship with the second fluid source 80. In yet other certain embodiments, only the layer 40 of the evaporator core 24 is in fluid communication with the first fluid source 70 and the internal thermal energy exchanger 78 is the layers 42, 44 of the evaporator core 24 in thermal energy exchange relationship with the second fluid source 80.

The internal thermal energy exchanger 78 shown is in thermal energy exchange relationship with the second fluid source 80 via a heat pipe 82. Various types of heat pipes can be employed such as a vapor chamber or a loop heat pipe, for example. In certain embodiments, the internal thermal energy exchanger 78 is in fluid communication with the second fluid source 80 through the heat pipe 82 and configured to receive a flow of a second fluid from the second fluid source 80 therein. The heat pipe 82 is configured to receive the second fluid therein and cause a flow of the second fluid from the second fluid source 80 to the internal thermal energy exchanger 78. Within the internal thermal energy exchanger 78, the second fluid absorbs or releases thermal energy to condition the air flowing through the HVAC module 12. The flow of the second fluid through the heat pipe 82 increases as a temperature difference between an end of the heat pipe 82 in thermal communication with the internal thermal energy exchanger 78 and an end of the heat pipe 82 in thermal communication with the second fluid source 80 increases. It is understood that the ends of the heat pipe 82 may be within, adjacent, or fluidly connected to the internal thermal energy exchanger 78 and the second fluid source 82 if desired. The heat pipe 82 contains no mechanical moving components and eliminates the use of a prime mover such as a compressor or a pump, for example. A valve 86 may be disposed in or adjacent the heat pipe 82 to selectively control the flow of the second fluid therethrough. Various valve types can be employed such as a butterfly valve, a ball valve, or a solenoid valve, for example.

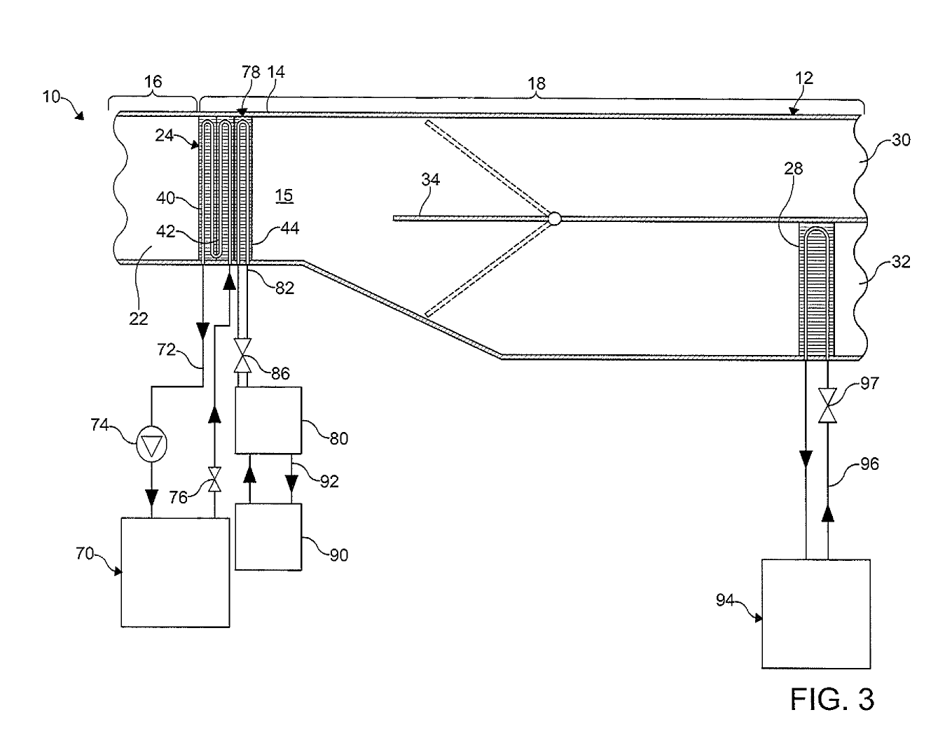

As a non-limiting example, the second fluid source 80 is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol, an acetone, sodium, and mercury), and the like, or any combination thereof, for example. The phase change material can also be impregnated with a thermally conductive material such as graphite powder, for example, to further enhance the transfer of thermal energy. As another non-limiting example, the second fluid source 80 is a fluid reservoir containing a coolant therein. As another non-limiting example, the second fluid source 80 is a fluid reservoir containing a phase change material coolant such as CryoSolplus, for example, therein. As yet another non-limiting example shown in FIG. 3, the second fluid source 80 is an external thermal energy exchanger (e.g. a shell and tube heat exchanger, a chiller, etc.) in fluid communication with at least one other system 90 of the vehicle via a conduit 92. It is understood that the external thermal energy exchanger may include a phase change material disposed therein if desired.

As shown, the heater core 28 is in fluid communication with a third fluid source 94 via a conduit 96. The heater core 28 is configured to receive a flow of a third fluid from the third fluid source 94 therein. The third fluid source 94 can be any conventional source of heated fluid such as the fuel-powered engine or a battery system of the vehicle, for example, and the third fluid can be any conventional fluid such as a phase change material, a coolant, or a phase change material coolant, for example. A valve 97 can be disposed in the conduit 96 to selectively control the flow of the third fluid therethrough. The heater core 28 is configured to facilitate a release of thermal energy from the third fluid to heat the air flowing therethrough when the fuel-powered engine of the vehicle is in operation.

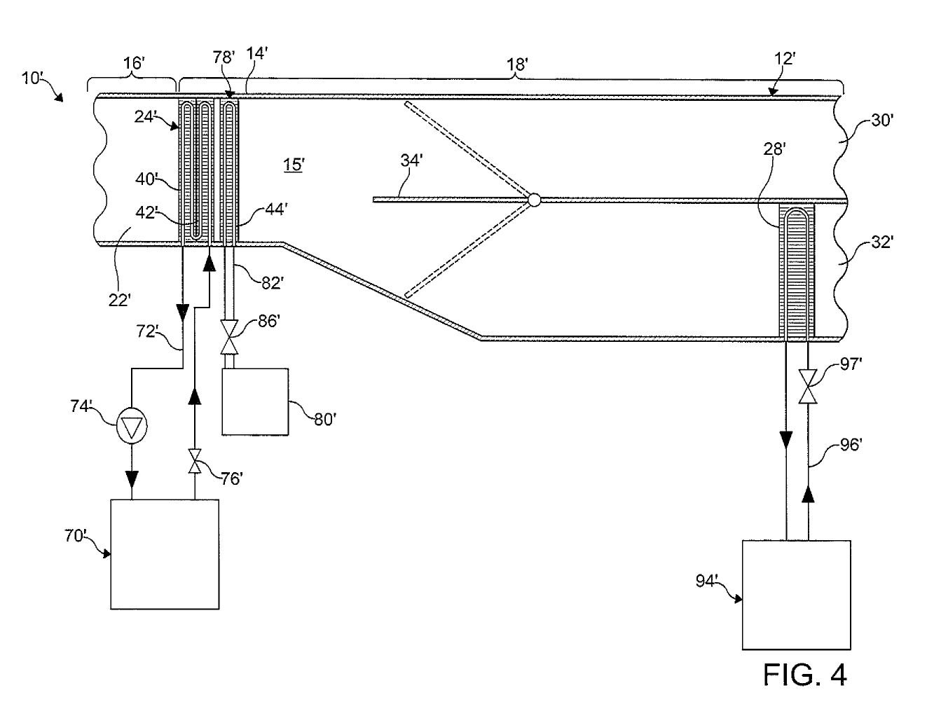

FIG. 4 shows an alternative embodiment of the HVAC system 10 illustrated in FIGS. 1 and 3. Structure similar to that illustrated in FIGS. 1-3 includes the same reference numeral and a prime (′) symbol for clarity. In FIG. 4, the HVAC system 10′ is substantially similar to the HVAC system 10, except a layer 44′ of an evaporator core 24′, which is the internal thermal energy exchanger 78′ in thermal energy exchange relationship with a second fluid source 80′, is spaced apart from the layers 40′, 42′ of the evaporator core 24′.

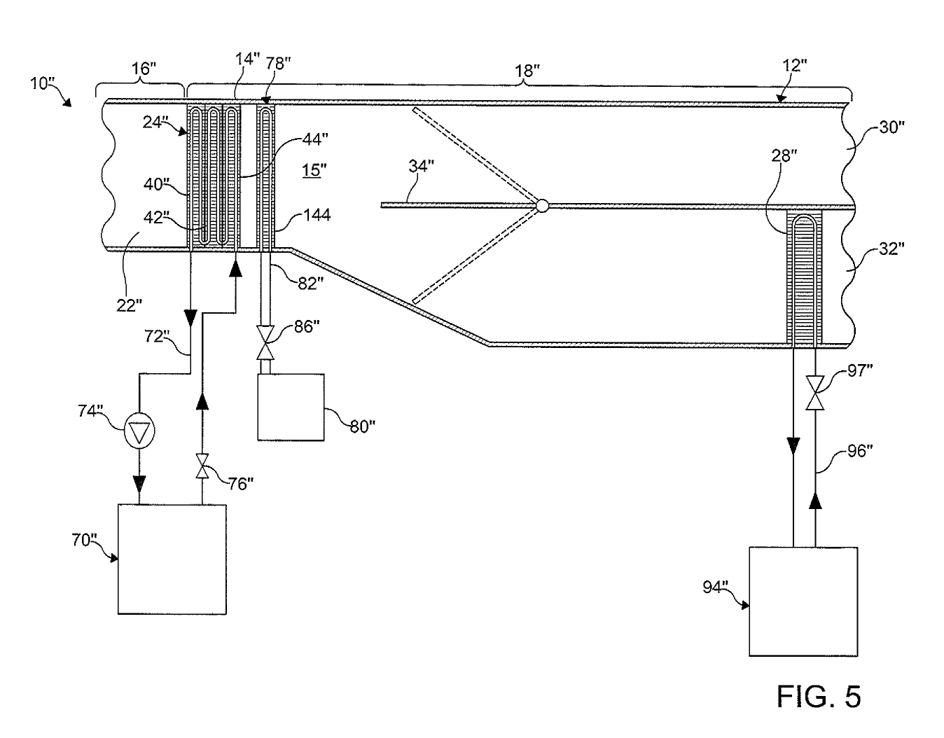

FIG. 5 shows another alternative embodiment of the HVAC systems 10, 10′ illustrated in FIGS. 1 and 3-4. Structure similar to that illustrated in FIGS. 1-4 includes the same reference numeral and a double prime (″) symbol for clarity. In FIG. 5, the HVAC system 10″ is substantially similar to the HVAC systems 10, 10′ except an internal thermal energy exchanger 78″ in thermal energy exchange relationship with a second fluid source 80″ is a separate thermal energy exchanger unit 144 instead of a portion of an evaporator core 24″.

The module 12″ illustrated includes a hollow main housing 14″ with an air flow conduit 15″ formed therein. The housing 14″ includes an inlet section 16″, a mixing and conditioning section 18″, and an outlet and distribution section (not shown). In the embodiment shown, an air inlet 22″ is formed in the inlet section 16″. The air inlet 22″ is in fluid communication with a supply of air (not shown). The supply of air can be provided from outside of the vehicle, recirculated from the passenger compartment of the vehicle, or a mixture of the two, for example. The inlet section 16″ is adapted to receive a blower wheel (not shown) therein to cause air to flow through the air inlet 22″. A filter (not shown) can be provided upstream, in, or downstream of the inlet section 16″ in respect of a direction of flow through the module 12″ if desired.

The mixing and conditioning section 18″ of the housing 14″ is configured to receive the evaporator core 24″ and a heater core 28″ therein. As shown, at least a portion of the mixing and conditioning section 18″ is divided into a first passage 30″ and a second passage 32″. In particular embodiments, the evaporator core 24″ is disposed upstream of a selectively positionable blend door 34″ in respect of the direction of flow through the module 12″ and the heater core 28″ is disposed in the second passage 32″ downstream of the blend door 34″ in respect of the direction of flow through the module 12″. A filter (not shown) can also be provided upstream of the evaporator core 24″ in respect of the direction of flow through the module 12″, if desired.

The evaporator core 24″ of the present invention is a multi-layer louvered-fin thermal energy exchanger. It is understood, however, that the evaporator core 24″ can be any suitable thermal energy exchanger as desired such a shell and tube heat exchanger, for example. In a non-limiting example, the evaporator core 24″ has a first layer 40″, a second layer 42″, and a third layer 44″ arranged substantially perpendicular to the direction of flow through the module 12″. Additional or fewer layers than shown can be employed as desired. The layers 40″, 42″, 44″ are arranged so the second layer 42″ is disposed downstream of the first layer 40″ and upstream of the third layer 44″ in respect of the direction of flow through the module 12″. It is understood, however, that the layers 40″, 42″, 44″ can be arranged as desired. The layers 40″, 42″, 44″ can be bonded together by any suitable method as desired such as brazing and welding, for example.

The layers 40″, 42″, 44″ of the evaporator core 24″, shown in FIG. 5, are in fluid communication with a first fluid source 70″ via a conduit 72″. The first fluid source 70″ includes a prime mover 74″ such as a compressor or a pump, for example, to cause a first fluid to circulate therein. Each of the layers 40″, 42″, 44″ is configured to receive a flow of the first fluid from the first fluid source 70″ therein. The first fluid absorbs thermal energy to condition the air flowing through the HVAC module 12″ when a fuel-powered engine of the vehicle, and thereby the prime mover 74″, is in operation. As a non-limiting example, the first fluid source 70″ is a refrigeration circuit, and the first fluid is a refrigerant such as R134a, HFO-1234yf, AC-5, AC-6, and CO₂, for example. A valve 76″ can be disposed in the conduit 72″ to selectively militate against the flow of the first fluid therethrough.

The HVAC system 10″ includes the internal thermal energy exchanger 78″ in thermal energy exchange relationship with the second fluid source 80″. As illustrated, the internal thermal energy exchanger 78″ is a separate component disposed downstream of and spaced apart from the evaporator core 24″ and upstream of a blend door 34″. The thermal energy exchanger 78″ can be any conventional thermal energy exchanger as desired such as a multi-layer louvered-fin thermal energy exchanger, for example.

The internal thermal energy exchanger 78″ shown is in thermal energy exchange relationship with the second fluid source 80″ via a heat pipe 82″. Various types of heat pipes can be employed such as a vapor chamber or a loop heat pipe, for example. In certain embodiments, the internal thermal energy exchanger 78″ is in fluid communication with the second fluid source 80″ through the heat pipe 82″ and configured to receive a flow of a second fluid from the second fluid source 80″ therein. The heat pipe 82″ is configured to receive the second fluid therein and cause a flow of the second fluid from the second fluid source 80″ to the internal thermal energy exchanger 78″. Within the internal thermal energy exchanger 78″, the second fluid absorbs or releases thermal energy to condition the air flowing through the HVAC module 12″. The flow of the second fluid through the heat pipe 82″ increases as a temperature difference between an end of the heat pipe 82″ in thermal communication with the internal thermal energy exchanger 78″ and an end of the heat pipe 82″ in thermal communication with the second fluid source 80″ increases. It is understood that the ends of the heat pipe 82″ may be within, adjacent, or fluidly connected to the internal thermal energy exchanger 78″ and the second fluid source 80″ if desired. The heat pipe 82″ contains no mechanical moving components and eliminates the use of a prime mover such as a compressor or a pump, for example. A valve 86″ may be disposed in or adjacent the heat pipe 82″ to selectively control the flow of the second fluid therethrough. Various valve types can be employed such as a butterfly valve, a ball valve, or a solenoid valve, for example.

As a non-limiting example, the second fluid source 80″ is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol, an acetone, sodium, and mercury), and the like, or any combination thereof, for example. The phase change material can also be impregnated with a thermally conductive material such as graphite powder, for example, to further enhance the transfer of thermal energy. As another non-limiting example, the second fluid source 80″ is a fluid reservoir containing a coolant therein. As another non-limiting example, the second fluid source 80″ is a fluid reservoir containing a phase change material coolant such as CryoSolplus, for example, therein. As yet another non-limiting example, the second fluid source 80″ is an external thermal energy exchanger (e.g. a shell and tube heat exchanger, a chiller, etc.) which includes a phase change material disposed therein and/or is in fluid communication with at least one other system 90″ of the vehicle via a conduit 92″.

As shown, the heater core 28″ is in fluid communication with a third fluid source 94″ via a conduit 96″. The heater core 28″ is configured to receive a flow of a third fluid from the third fluid source 94″ therein. The third fluid source 94″ can be any conventional source of heated fluid such as the fuel-powered engine or a battery system of the vehicle, for example, and the third fluid can be any conventional fluid such as a phase change material, a coolant, or a phase change material coolant, for example. A valve 97″ can be disposed in the conduit 96″ to selectively militate against the flow of the third fluid therethrough. The heater core 28″ is configured to facilitate a release of thermal energy from the third fluid to heat the air flowing therethrough when the fuel-powered engine of the vehicle is in operation.

It is understood that the operation of the HVAC systems 10, 10′ including the internal thermal energy exchanger 78, 78′ is substantially similar to the operation of the HVAC system 10″. For simplicity, only the operation of the HVAC system 10″ including the internal thermal energy exchanger 78″ is described hereinafter.

In operation, the HVAC system 10″ conditions air by heating or cooling the air, and providing the conditioned air to the passenger compartment of the vehicle. Air from the supply of air is received in housing 14″ and flows through the module 12″.

In a cooling mode or an engine-off cooling mode of the HVAC system 10″, the blend door 34″ is positioned in one of a first position permitting air from the evaporator core 24″ and the thermal energy exchanger 78″ to only flow into the first passage 30″, a second position permitting the air from the evaporator core 24″ and the thermal energy exchanger 78″ to only flow into the second passage 32″, and an intermediate position permitting the air from the evaporator core 24″ and the thermal energy exchanger 78″ to flow through both the first passage 30″ and the second passage 32″. In a heating mode or an engine-off heating mode of the HVAC system 10″, the blend door 34″ is positioned either in the second position permitting the air from the evaporator core 24″ and the thermal energy exchanger 78″ to only flow into the second passage 32″ and through the heater core 28″ or in the intermediate position permitting the air from the evaporator core 24″ and the thermal energy exchanger 78″ to flow through the first passage 30″ and the second passage 32″ and through the heater core 28″. In a cold storage charge mode, a hot storage charge mode, or a recirculation heating mode of the HVAC system 10″, the blend door 34″ is positioned in one of the first position permitting the air from the evaporator core 24″ and the thermal energy exchanger 78″ to only flow into the first passage 30″, the second position permitting the air from the evaporator core 24″ and the thermal energy exchanger 78″ to only flow into the second passage 32″, and the intermediate position permitting the air from the evaporator core 24″ and the thermal energy exchanger 78″ to flow through both the first passage 30″ and/or the second passage 32″.

When the fuel-powered engine of the vehicle is in operation and the HVAC system 10″ is in the cooling mode or the cold storage charge mode, the first fluid from the first fluid source 70″ circulates through the conduit 72″ to the evaporator core 24″. However, the valve 97″ is closed to militate against the circulation of the third fluid from the third fluid source 94″ through the conduit 96″ to the heater core 28″. The second fluid from the second fluid source 80″ flows through the heat pipe 82″ to the internal thermal energy exchanger 78″. Specifically, a generally vapor-phase second fluid located in the end of the heat pipe 82″ in thermal communication with the internal thermal energy exchanger 78″ releases thermal energy to the air flowing through the air flow conduit 15″ and condenses into a generally liquid-phase second fluid. The generally liquid-phase second fluid then travels along the heat pipe 82″ through either capillary action or gravity to the end of the heat pipe 82″ in thermal communication with the second fluid source 80″. Within the second fluid source 80″, the generally liquid-phase second fluid absorbs thermal energy to cool or charge at least one of the phase change material, the coolant, and the phase change material coolant. The absorption of thermal energy causes the generally liquid-phase second fluid to evaporate into the generally vapor-phase second fluid. The generally vapor-phase second fluid then returns to the end of the heat pipe 82″ in thermal communication with the internal thermal energy exchanger 78″ where the generally vapor-phase second fluid condenses and repeats the cycle. Accordingly, the air from the inlet section 16″ flows into the evaporator core 24″ where the air is cooled to a desired temperature by a transfer of thermal energy from the air to the first fluid from the first fluid source 70″. The conditioned air then flows from the evaporator core 24″ to the internal thermal energy exchanger 78″. As the conditioned air flows through the internal thermal energy exchanger 78″, the conditioned air absorbs thermal energy from the second fluid. The transfer of thermal energy from the second fluid to the conditioned air cools the second fluid, and thereby the phase change material, the coolant, the phase change material coolant, or any combination thereof in the second fluid source 80″. The conditioned air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 94″ to circulate through the conduit 96″ to the heater core 28″, and thereby demist the conditioned air flowing through the second passage 32″.

In other certain embodiments, when the fuel-powered engine of the vehicle is in operation and the HVAC system 10″ is operating in the cooling mode, the first fluid from the first fluid source 70″ circulates through the conduit 72″ to the evaporator core 24″. However, the second fluid from the second fluid source 80″ does not flow through the heat pipe 82″ to the internal thermal energy exchanger 78″. In certain embodiments, the valve 86″ is closed to militate against the flow of the second fluid from the second fluid source 80″. Additionally, the valve 97″ is closed to militate against the circulation of the third fluid from the third fluid source 94″ through the conduit 96″ to the heater core 28″. Accordingly, the air from the inlet section 16″ flows into the evaporator core 24″ where the air is cooled to a desired temperature by a transfer of thermal energy from the air to the first fluid from the first fluid source 70″. The conditioned air then flows from the evaporator core 24″ to the internal thermal energy exchanger 78″. As the conditioned air flows through the internal thermal energy exchanger 78″, the temperature of the conditioned air is relatively unaffected. The conditioned air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 94″ to circulate through the conduit 96″ to the heater core 28″, and thereby demist the conditioned air flowing through the second passage 32″.

When the fuel-powered engine of the vehicle is not in operation and the HVAC system 10″ is in the engine-off cooling mode, the first fluid from the first fluid source 70″ does not circulate through the conduit 72″ to the evaporator core 24″. Additionally, the third fluid from the third fluid source 94″ does not circulate through the conduit 96″ to the heater core 28″. However, the second fluid from the second fluid source 80″ flows through the heat pipe 82″ to the internal thermal energy exchanger 78″. Specifically, a generally liquid-phase second fluid located in the end of the heat pipe 82″ in thermal communication with the internal thermal energy exchanger 78″ absorbs thermal energy from the air flowing through the air flow conduit 15″ and evaporates into a generally vapor-phase second fluid. The generally vapor-phase second fluid then travels along the heat pipe 82″ to the end of the heat pipe 82″ in thermal communication with the second fluid source 80″. Within the second fluid source 80″, the generally vapor-phase second fluid releases thermal energy to at least one of the phase change material, the coolant, and the phase change material coolant contained therein. The transfer of thermal energy causes the generally vapor-phase second fluid to condense into the generally liquid-phase second fluid. The generally liquid-phase second fluid then returns through either capillary action or gravity to the end of the heat pipe 82″ in thermal communication with the internal thermal energy exchanger 78″ where the generally liquid-phase second fluid evaporates and repeats the cycle. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is cooled to a desired temperature by a transfer of thermal energy from the air to the second fluid from the second fluid source 80″. The conditioned air then exits the thermal energy exchanger 78″ and is selectively permitted by the blend door 34″ to flow through the first passage 30″ and/or the second passage 32″

When the fuel-powered engine of the vehicle is in operation and the HVAC system 10″ is in the heating mode, the first fluid from the first fluid source 70″ does not circulate through the conduit 72″ to the evaporator core 24″. Similarly, the second fluid from the second fluid source 80″ does not flow through the heat pipe 82″ to the internal thermal energy exchanger 78″. In certain embodiments, the valve 86″ is closed to militate against the flow of the second fluid from the second fluid source 80″. However, the third fluid from the third fluid source 94″ circulates through the conduit 96″ to the heater core 28″. Accordingly, the air from the inlet section 16″ flows through the evaporator core 24″ and the internal thermal energy exchanger 78″ where a temperature of the air is relatively unaffected. The unconditioned air then exits the evaporator 24″ and the internal thermal energy exchanger 78″ and is selectively permitted by the blend door 34″ to flow through the first passage 30″ and/or the second passage 32″ through the heater core 28″ to be heated to a desired temperature.

In other certain embodiments, when the fuel-powered engine of the vehicle is in operation and the HVAC system 10″ is operating in an alternative heating mode, the first fluid from the first fluid source 70″ does not circulate through the conduit 72″ to the evaporator core 24″. However, the third fluid from the third fluid source 94″ circulates through the conduit 96″ to the heater core 28″ and the second fluid from the second fluid source 80″ flows through the heat pipe 82″ to the internal thermal energy exchanger 78″. Specifically, a generally vapor-phase second fluid located in the end of the heat pipe 82″ in thermal communication with the internal thermal energy exchanger 78″releases thermal energy to the air flowing through the air flow conduit 15″ and condenses into a generally liquid-phase second fluid. The generally liquid-phase second fluid then travels along the heat pipe 82″ through either capillary action or gravity to the end of the heat pipe 82″ in thermal communication with the second fluid source 80″. Within the second fluid source 80″, the generally liquid-phase second fluid absorbs thermal energy from at least one of the phase change material, the coolant, and the phase change material coolant and evaporates into the generally vapor-phase second fluid. The generally vapor-phase second fluid then returns to the end of the heat pipe 82″ in thermal communication with the internal thermal energy exchanger 78″ where the generally vapor-phase second fluid condenses and repeats the cycle. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is heated to a desired temperature by a transfer of thermal energy from the second fluid from the second fluid source 80″ to the air flowing through the internal thermal energy exchanger 78″. The conditioned air then exits the internal thermal energy exchanger 78″ and is selectively permitted by the blend door 34″ to flow through the first passage 30″ and/or the second passage 32″ through the heater core 28″ to be further heated to a desired temperature.

In other certain embodiments, when the fuel-powered engine of the vehicle is not in operation and the HVAC system 10″ is operating in an engine-off heating mode, the first fluid from the first fluid source 70″ does not circulate through the conduit 72″ to the evaporator core 24″. Additionally, the third fluid from the third fluid source 94″ does not circulate through the conduit 96″ to the heater core 28″. However, the second fluid from the second fluid source 80″ flows through the heat pipe 82″ to the internal thermal energy exchanger 78″. Specifically, a generally vapor-phase second fluid located in the end of the heat pipe 82″ in thermal communication with the internal thermal energy exchanger 78″ releases thermal energy to the air flowing through the air flow conduit 15″ and condenses into a generally liquid-phase second fluid. The generally liquid-phase second fluid then travels along the heat pipe 82″ through either capillary action or gravity to the end of the heat pipe 82″ in thermal communication with the second fluid source 80″. Within the second fluid source 80″, the generally liquid-phase second fluid absorbs thermal energy from at least one of the phase change material, the coolant, and the phase change material coolant and evaporates into the generally vapor-phase second fluid. The generally vapor-phase second fluid then returns to the end of the heat pipe 82″ in thermal communication with the internal thermal energy exchanger 78″ where the generally vapor-phase second fluid condenses and repeats the cycle. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is heated to a desired temperature by a transfer of thermal energy from the second fluid from the second fluid source 80″ to the air flowing through the internal thermal energy exchanger 78″. The conditioned air then exits the internal thermal energy exchanger 78″ and is selectively permitted by the blend door 34″ to flow through the first passage 30″ and/or the second passage 32″.

When the fuel-powered engine of the vehicle is in operation and the HVAC system 10″ is in the recirculation heating mode or the hot storage charge mode, the first fluid from the first fluid source 70″ does not circulate through the conduit 72″ to the evaporator core 24″. Additionally, the valve 97″ is closed to militate against the circulation of the third fluid from the third fluid source 94″ through the conduit 96″ to the heater core 28″. However, the second fluid from the second fluid source 80″ flows through the heat pipe 82″ to the internal thermal energy exchanger 78″. Specifically, a generally liquid-phase second fluid located in the end of the heat pipe 82″ in thermal communication with the internal thermal energy exchanger 78″ absorbs thermal energy from the air flowing through the air flow conduit 15″ and evaporates into a generally vapor-phase second fluid. The generally vapor-phase second fluid then travels along the heat pipe 82″ to the end of the heat pipe 82″ in thermal communication with the second fluid source 80″. Within the second fluid source 80″, the generally vapor-phase second fluid releases thermal energy to heat or charge at least one of the phase change material, the coolant, and the phase change material coolant contained therein. The transfer of thermal energy causes the generally vapor-phase second fluid to condense into the generally liquid-phase second fluid. The generally liquid-phase second fluid then returns through either capillary action or gravity to the end of the heat pipe 82″ in thermal communication with the internal thermal energy exchanger 78″ where the generally liquid-phase second fluid evaporates and repeats the cycle. Accordingly, a re-circulated air from a passenger compartment of the vehicle flow through the inlet section 16″ and into the evaporator core 24″ where a temperature of the air is relatively unaffected. The re-circulated air then flows from the evaporator core 24″ to the internal thermal energy exchanger 78″. As the air flows through the internal thermal energy exchanger 78″, the re-circulated air transfers thermal energy to the second fluid. The transfer of thermal energy from the re-circulated air to the second fluid heats the second fluid. The second fluid then flows to the second fluid source 80″ and releases thermal energy to heat or charge the phase change material, the coolant, the phase change material coolant, or any combination thereof contained in the second fluid source 80″. The re-circulated air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 94″ to circulate through the conduit 96″ to the heater core 28″ and heat the re-circulated air flowing through the second passage 32″ to a desired temperature.

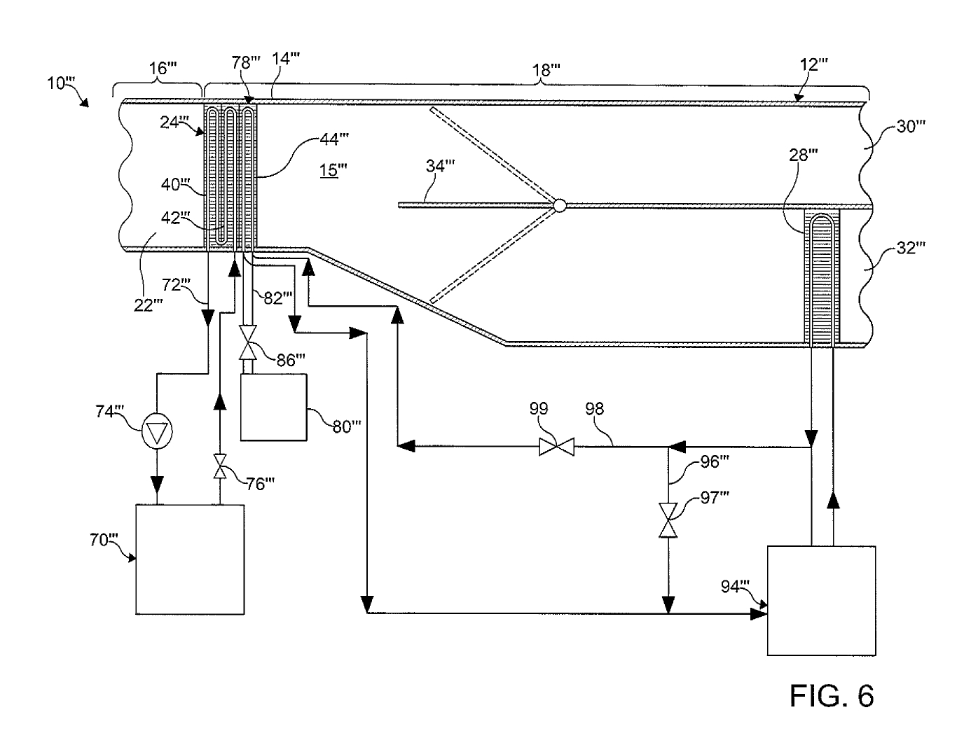

FIG. 6 shows another alternative embodiment of the HVAC systems 10, 10′, 10″ illustrated in FIGS. 1 and 3-5. Structure similar to that illustrated in FIGS. 1-5 includes the same reference numeral and a triple prime (′″) symbol for clarity. In FIG. 6, the HVAC system 10′″ is substantially similar to the HVAC systems 10, 10′, 10″ except a layer 44″ of an evaporator core 24″, which is the internal thermal energy exchanger 78″, is in thermal energy exchange relationship with a second fluid source 80″ and a third fluid source 94′″.

The HVAC system 10′″ typically provides heating, ventilation, and air conditioning for a passenger compartment of a vehicle (not shown). The HVAC system 10′″ includes a control module 12′″ to control at least a temperature of the passenger compartment. The module 12′″ illustrated includes a hollow main housing 14′″ with an air flow conduit 15′″ formed therein. The housing 14′″ includes an inlet section 16′″, a mixing and conditioning section 18′″, and an outlet and distribution section (not shown). In the embodiment shown, an air inlet 22′″ is formed in the inlet section 16′″. The air inlet 22′″ is in fluid communication with a supply of air (not shown). The supply of air can be provided from outside of the vehicle, recirculated from the passenger compartment of the vehicle, or a mixture of the two, for example. The inlet section 16′″ is adapted to receive a blower wheel (not shown) therein to cause air to flow through the air inlet 22′″. A filter (not shown) can be provided upstream, in, or downstream of the inlet section 16′″ in respect of a direction of flow through the module 12′″ if desired.

The mixing and conditioning section 18′″ of the housing 14′″ is configured to receive the evaporator core 24′″ and a heater core 28′″ therein. As shown, at least a portion of the mixing and conditioning section 18′″ is divided into a first passage 30′″ and a second passage 32′″. In particular embodiments, the evaporator core 24′″ is disposed upstream of a selectively positionable blend door 34′″ in respect of the direction of flow through the module 12′″ and the heater core 28′″ is disposed in the second passage 32″ downstream of the blend door 34″ in respect of the direction of flow through the module 12′″. A filter (not shown) can also be provided upstream of the evaporator core 24′″ in respect of the direction of flow through the module 12′″, if desired.

The evaporator core 24′″ of the present invention is a multi-layer louvered-fin thermal energy exchanger. It is understood, however, that the evaporator core 24′″ can be any suitable thermal energy exchanger as desired such a shell and tube heat exchanger, for example. In a non-limiting example, the evaporator core 24′″ has a first layer 40′″, a second layer 42′″, and a third layer 44′″ arranged substantially perpendicular to the direction of flow through the module 12′″. Additional or fewer layers than shown can be employed as desired. The layers 42′″, 44′″ are arranged so the second layer 42′″ is disposed downstream of the first layer 40′″ and upstream of the third layer 44′″ in respect of the direction of flow through the module 12′″. It is understood, however, that the layers 40′″, 42′″, 44′″ can be arranged as desired. The layers 40′″, 42′″, 44′″ can be bonded together by any suitable method as desired such as brazing and welding, for example.

The layers 40′″, 42′″ of the evaporator core 24′″ shown are in fluid communication with a first fluid source 70′″ via a conduit 72′″. It is understood, however, that any of the layers 40′″, 44′″, alone or in combination, may be in fluid communication with the first fluid source 70′″ via the conduit 72′″. The first fluid source 70′″ includes a prime mover 74′″ such as a compressor or a pump, for example, to cause a first fluid to circulate therein. Each of the layers 40′″, 42′″ is configured to receive a flow of the first fluid from the first fluid source 70′″ therein. The first fluid absorbs thermal energy to condition the air flowing through the HVAC module 12′″ when a fuel-powered engine of the vehicle, and thereby the prime mover 74′″, is in operation. As a non-limiting example, the first fluid source 70′″ is a refrigeration circuit, and the first fluid is a refrigerant such as R134a, HFO-1234yf, AC-5, AC-6, and CO₂, for example. A valve 76′″ can be disposed in the conduit 72′″ to selectively militate against the flow of the first fluid therethrough.

The HVAC system 10′″ includes the internal thermal energy exchanger 78′″ in thermal energy exchange relationship with the second fluid source 80′″. As illustrated, the internal thermal energy exchanger 78′″ is the layer 44″ of the evaporator core 24′″. It is understood, however, that the thermal energy exchanger 78′″ may be any of the layers 42′″, 44′″ of the evaporator core 24′″, alone or in combination, in thermal energy exchange relationship with the second fluid source 80′″. In another particular embodiment, the internal thermal energy exchanger 78′″ is a separate thermal energy exchanger disposed downstream of and spaced apart from the evaporator core 24′″ and upstream of the blend door 34′″. It is understood that the internal thermal energy exchanger 78′″ can be any conventional thermal energy exchanger as desired.

The internal thermal energy exchanger 78′″ (e.g. the layer 44′″ as shown in FIG. 6, the layer 42′″, or both the layers 42′″, 44′″ of the evaporator core 24′″) is in thermal energy exchange relationship with the second fluid source′″ via a heat pipe 82′″. Various types of heat pipes can be employed such as a vapor chamber or a loop heat pipe, for example. In certain embodiments, the internal thermal energy exchanger 78′″ is in fluid communication with the second fluid source 80′″ through the heat pipe 82′″ and configured to receive the second fluid from the second fluid source 80′″ therein. The heat pipe 82′″ is configured to receive the second fluid therein and cause a flow of the second fluid from the second fluid source 80′″ to the internal thermal energy exchanger 78′″. Within the internal thermal energy exchanger 78′″, the second fluid absorbs or releases thermal energy to condition the air flowing through the HVAC module 12′″. The flow of the second fluid through the heat pipe 82′″ increases as a temperature difference between an end of the heat pipe 82′″ in thermal communication with the internal thermal energy exchanger 78′″ and an end of the heat pipe 82′″ in thermal communication with the second fluid source 80′″ increases. It is understood that the ends of the heat pipe 82′″ may be within, adjacent, or fluidly connected to the internal thermal energy exchanger 78′″ and the second fluid source 80′″ if desired. The heat pipe 82′″ contains no mechanical moving components and eliminates the use of a prime mover such as a compressor or a pump, for example. A valve 86′″ may be disposed in or adjacent the heat pipe 82′″ to selectively control the flow of the second fluid therethrough. Various valve types can be employed such as a butterfly valve, a ball valve, or a solenoid valve, for example.

As a non-limiting example, the second fluid source 80′″ is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol, an acetone, sodium, and mercury), and the like, or any combination thereof, for example. The phase change material can also be impregnated with a thermally conductive material such as graphite powder, for example, to further enhance the transfer of thermal energy. As another non-limiting example, the second fluid source 80′″ is a fluid reservoir containing a coolant therein. As another non-limiting example, the second fluid source 80′″ is a fluid reservoir containing a phase change material coolant such as CryoSolplus, for example, therein. As yet another non-limiting example, the second fluid source 80′″ is an external thermal energy exchanger (e.g. a shell and tube heat exchanger, a chiller, etc.) which includes a phase change material disposed therein and/or is in fluid communication with at least one other system 90′″ of the vehicle via a conduit 92′″.

As shown, a third fluid source 94′″ is in fluid communication with the heater core 28′″ via a conduit 96′″. The heater core 28′″ is configured to receive a flow of a third fluid from the third fluid source 94′″ therein. The third fluid source 94′″ can be any conventional source of heated fluid such as the fuel-powered engine or a battery system of the vehicle, for example, and the third fluid can be any conventional fluid such as a phase change material, a coolant, or a phase change material coolant, for example. A valve 97′″ can be disposed in the conduit 96′″ to selectively control the flow of the third fluid therethrough. The heater core 28′″ is configured to facilitate a release of thermal energy from the third fluid to heat the air flowing therethrough when the fuel-powered engine of the vehicle is in operation.

The third fluid source 94′″ is also in fluid communication with the internal thermal energy exchanger 78′ via a conduit 98. The internal thermal energy exchanger 78′″ is configured to receive a flow of the third fluid from the third fluid source 94′″. The internal thermal energy exchanger 78′″ is configured to facilitate a release of thermal energy from the third fluid to heat the air flowing therethrough when the fuel-powered engine of the vehicle is in operation. Accordingly, a size and capacity of the heater core 28 may be decreased, which may cause a decrease in air side pressure drop during heating modes of the HVAC system 10′″, as well as an increase in available package space within the module 12′″. A valve 99′″ can be disposed in the conduit 98′″ to selectively control the flow of the third fluid therethrough.

In operation, the HVAC system 10′″ conditions air by heating or cooling the air, and providing the conditioned air to the passenger compartment of the vehicle. Air from the supply of air is received in the inlet section 16′″ of the housing 14′″ in the air inlet 22′″ and flows through the housing 14′″ of the module 12′″.

In a cooling mode or an engine-off cooling mode of the HVAC system 10′″, the blend door 34′″ is positioned in one of a first position permitting air from the evaporator core 24′″ and the thermal energy exchanger 78′″ to only flow into the first passage 30′″, a second position permitting the air from the evaporator core 24′″ and the thermal energy exchanger 78′″ to only flow into the second passage 32′″, and an intermediate position permitting the air from the evaporator core 24′″ and the thermal energy exchanger 78′″ to flow through both the first passage 30′″ and the second passage 32′″. In a heating mode or an engine-off heating mode of the HVAC system 10′″, the blend door 34′″ is positioned either in the second position permitting the air from the evaporator core 24′″ and the thermal energy exchanger 78′″ to only flow into the second passage 32′″ and through the heater core 28′″ or in the intermediate position permitting the air from the evaporator core 24′″ and the thermal energy exchanger 78′″ to flow through the first passage 30′″ and the second passage 32′″ and through the heater core 28′″. In a cold storage charge mode, a hot storage charge mode, or a recirculation heating mode of the HVAC system 10′″, the blend door 34′″ is positioned in one of the first position permitting the air from the evaporator core 24′″ and the thermal energy exchanger 78′″ to only flow into the first passage 30′″, the second position permitting the air from the evaporator core 24′″ and the thermal energy exchanger 78′″ to only flow into the second passage 32′″, and the intermediate position permitting the air from the evaporator core 24′″ and the thermal energy exchanger 78′″ to flow through both the first passage 30′″ and/or the second passage 32′″.

When the fuel-powered engine of the vehicle is in operation and the HVAC system 10′″ is in the cooling mode or the cold storage charge mode, the first fluid from the first fluid source 70′″ circulates through the conduit 72′″ to the evaporator core 24′″. However, the valves 97′″, 99 are closed to militate against the circulation of the third fluid from the third fluid source 94′″ through the respective conduits 96′″, 98 to the heater core 28′″ and the internal thermal energy exchanger 78′″. The second fluid from the second fluid source 80′″ flows through the heat pipe 82′″ to the internal thermal energy exchanger 78′″. Specifically, a generally vapor-phase second fluid located in the end of the heat pipe 82′″ in thermal communication with the internal thermal energy exchanger 78′″ releases thermal energy to the air flowing through the air flow conduit 15′″ and condenses into a generally liquid-phase second fluid. The generally liquid-phase second fluid then travels along the heat pipe 82′″ through either capillary action or gravity to the end of the heat pipe 82′″ in thermal communication with the second fluid source 80′″. Within the second fluid source 80′″, the generally liquid-phase second fluid absorbs thermal energy to cool or charge at least one of the phase change material, the coolant, and the phase change material coolant. The absorption of thermal energy causes the generally liquid-phase second fluid to evaporate into the generally vapor-phase second fluid. The generally vapor-phase second fluid then returns to the end of the heat pipe 82′″ in thermal communication with the internal thermal energy exchanger 78′″ where the generally vapor-phase second fluid condenses and repeats the cycle. Accordingly, the air from the inlet section 16′ flows into the evaporator core 24′″ where the air is cooled to a desired temperature by a transfer of thermal energy from the air to the first fluid from the first fluid source 70′″. The conditioned air then flows from the evaporator core 24′″ to the internal thermal energy exchanger 78′″. As the conditioned air flows through the internal thermal energy exchanger 78′″, the conditioned air absorbs thermal energy from the second fluid. The transfer of thermal energy from the second fluid to the conditioned air cools the second fluid, and thereby the phase change material, the coolant, the phase change material coolant, or any combination thereof in the second fluid source 80′″. The conditioned air then exits the internal thermal energy exchanger 78′″ and is selectively permitted by the blend door 34′″ to flow through the first passage 30′″ and/or the second passage 32′″. It is understood, however, that in other embodiments the valve 97′″ is open, permitting the third fluid from the third fluid source 94′″ to circulate through the conduit 96′″ to the heater core 28′″, and thereby demist the conditioned air flowing through the second passage 32′″.

In other certain embodiments, when the fuel-powered engine of the vehicle is in operation and the HVAC system 10′″ is operating in the cooling mode, the first fluid from the first fluid source 70′″ circulates through the conduit 72′″ to the evaporator core 24′″. However, the second fluid from the second fluid source 80′″ does not flow through the heat pipe 82′″ to the internal thermal energy exchanger 78′″. In certain embodiments, the valve 86′″ is closed to militate against the flow of the second fluid from the second fluid source 80′″. Additionally, the valves 97′″, 99 are closed to militate against the circulation of the third fluid from the third fluid source 94′″ through the respective conduits 96′″, 98 to the heater core 28′″ and the internal thermal energy exchanger 78′″. Accordingly, the air from the inlet section 16′″ flows into the evaporator core 24′″ where the air is cooled to a desired temperature by a transfer of thermal energy from the air to the first fluid from the first fluid source 70′″. The conditioned air then flows from the evaporator core 24′″ to the internal thermal energy exchanger 78′″. As the conditioned air flows through the internal thermal energy exchanger 78′″, the temperature of the conditioned air is relatively unaffected. The conditioned air then exits the internal thermal energy exchanger 78′″ and is selectively permitted by the blend door 34′″ to flow through the first passage 30′″ and/or the second passage 32′″. It is understood, however, that in other embodiments the valve 97′″ is open, permitting the third fluid from the third fluid source 94′″ to circulate through the conduit 96′″ to the heater core 28′″, and thereby demist the conditioned air flowing through the second passage 32′″.

When the fuel-powered engine of the vehicle is not in operation and the HVAC system 10′″ is in the engine-off cooling mode, the first fluid from the first fluid source 70′″ does not circulate through the conduit 72′″ to the evaporator core 24′″. Additionally, the third fluid from the third fluid source 94′″ does not circulate through the respective conduits 96′″, 98 to the heater core 28′″ and the internal thermal energy exchanger 78′″. However, second fluid from the second fluid source 80′″ flows through the heat pipe 82′″ to the internal thermal energy exchanger 78′″. Specifically, a generally liquid-phase second fluid located in the end of the heat pipe 82′″ in thermal communication with the internal thermal energy exchanger 78′″ absorbs thermal energy from the air flowing through the air flow conduit 15′″ and evaporates into a generally vapor-phase second fluid. The generally vapor-phase second fluid then travels along the heat pipe 82′″ to the end of the heat pipe 82′″ in thermal communication with the second fluid source 80′″. Within the second fluid source 80′″, the generally vapor-phase second fluid releases thermal energy to at least one of the phase change material, the coolant, and the phase change material coolant contained therein. The transfer of thermal energy causes the generally vapor-phase second fluid to condense into the generally liquid-phase second fluid. The generally liquid-phase second fluid then returns through either capillary action or gravity to the end of the heat pipe 82′″ in thermal communication with the internal thermal energy exchanger 78′″ where the generally liquid-phase second fluid evaporates and repeats the cycle. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is cooled to a desired temperature by a transfer of thermal energy from the air to the second fluid from the second fluid source 80′″. The conditioned air then exits the thermal energy exchanger 78′″ and is selectively permitted by the blend door 34′″ to flow through the first passage 30′″ and/or the second passage 32′″.

When the fuel-powered engine of the vehicle is in operation and the HVAC system 10′″ is in the heating mode, the first fluid from the first fluid source 70′″ does not circulate through the conduit 72′″ to the evaporator core 24′″. Similarly, the second fluid from the second fluid source 80′″ does not flow through the heat pipe 82′″ to the internal thermal energy exchanger 78′″. In certain embodiments, the valve 86′″ is closed to militate against the flow of the second fluid from the second fluid source 80′. However, the third fluid from the third fluid source 94′″ circulates through the conduit 96′″ to the heater core 28′″. The valve 99 is closed to militate against the circulation of the third fluid through the conduit 98 to the internal thermal energy exchanger 78′″. Accordingly, the air from the inlet section 16′″ flows through the evaporator core 24′″ and the internal thermal energy exchanger 78′″ where a temperature of the air is relatively unaffected. The unconditioned air then exits the evaporator 24′″ and the internal thermal energy exchanger 78′″ and is selectively permitted by the blend door 34′″ to flow through the first passage 30′″ and/or the second passage 32′″ through the heater core 28′″ to be heated to a desired temperature.

In other certain embodiments, when the fuel-powered engine of the vehicle is in operation and the HVAC system 10′″ is operating in an alternative heating mode, the first fluid from the first fluid source 70′″ does not circulate through the conduit 72′″ to the evaporator core 24′. Additionally, the valve 99 is closed to militate against the circulation of the third fluid through the conduit 98 to the internal thermal energy exchanger 78′″. However, the third fluid from the third fluid source 94′″ circulates through the conduit 96′″ to the heater core 28′″ and the second fluid from the second fluid source 80′″ flows through the heat pipe 82′″ to the internal thermal energy exchanger 78′. Specifically, a generally vapor-phase second fluid located in the end of the heat pipe 82′″ in thermal communication with the internal thermal energy exchanger 78′″ releases thermal energy to the air flowing through the air flow conduit 15′″ and condenses into a generally liquid-phase second fluid. The generally liquid-phase second fluid then travels along the heat pipe 82′″ through either capillary action or gravity to the end of the heat pipe 82′″ in thermal communication with the second fluid source 80′″. Within the second fluid source 80′″, the generally liquid-phase second fluid absorbs thermal energy from at least one of the phase change material, the coolant, and the phase change material coolant and evaporates into the generally vapor-phase second fluid. The generally vapor-phase second fluid then returns to the end of the heat pipe 82′″ in thermal communication with the internal thermal energy exchanger 78′″ where the generally vapor-phase second fluid condenses and repeats the cycle. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the second fluid from the second fluid source 80′″ to the air flowing through the internal thermal energy exchanger 78′″. The conditioned air then exits the internal thermal energy exchanger 78′″ and is selectively permitted by the blend door 34′″ to flow through the first passage 30′″ and/or the second passage 32′″ through the heater core 28′″ to be further heated to a desired temperature.

When the fuel-powered engine of the vehicle is in operation and the HVAC system 10′″ is operating in an alternative heating mode, the first fluid from the first fluid source 70′″ does not circulate through the conduit 72′″ to the evaporator core 24′″. Similarly, the second fluid from the second fluid source 80′″ does not flow through the heat pipe 82′″ to the internal thermal energy exchanger 78′″. In certain embodiments, the valve 86′″ is closed to militate against the flow of the second fluid from the second fluid source 80′″. However, the third fluid from the third fluid source 94′″ circulates through the respective conduits 96′″, 98 to the heater core 28′″ and the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the third fluid from the third fluid source 94′″ to the air flowing through the internal thermal energy exchanger 78′″. The conditioned air then exits the internal thermal energy exchanger 78′″ and is selectively permitted by the blend door 34′″ to flow through the first passage 30′″ and/or the second passage 32′″ through the heater core 28′″ to be further heated to a desired temperature.

In other certain embodiments, when the fuel-powered engine of the vehicle is in operation and the HVAC system 10′″ is operating in an alternative heating mode, the first fluid from the first fluid source 70′″ does not circulate through the conduit 72′″ to the evaporator core 24′″. However, the third fluid from the third fluid source 94′″ circulates through the respective conduits 96′″, 98 to the heater core 28′″ and the internal thermal energy exchanger 78′″. Additionally, the second fluid from the second fluid source 80′″ flows through the heat pipe 82′″ to the internal thermal energy exchanger 78′″. Specifically, a generally vapor-phase second fluid located in the end of the heat pipe 82′″ in thermal communication with the internal thermal energy exchanger 78′″ releases thermal energy to the air flowing through the air flow conduit 15′″ and condenses into a generally liquid-phase second fluid. The generally liquid-phase second fluid then travels along the heat pipe 82′″ through either capillary action or gravity to the end of the heat pipe 82′″ in thermal communication with the second fluid source 80′″. Within the second fluid source 80′″, the generally liquid-phase second fluid absorbs thermal energy from at least one of the phase change material, the coolant, and the phase change material coolant and evaporates into the generally vapor-phase second fluid. The generally vapor-phase second fluid then returns to the end of the heat pipe 82′″ in thermal communication with the internal thermal energy exchanger 78′″ where the generally vapor-phase second fluid condenses and repeats the cycle. In certain embodiments, the second fluid mixes with the third fluid before, in, or after flowing through the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the second fluid from the second fluid source 80′″ and the third fluid from the third fluid source 94′″ or a mixture thereof to the air flowing through the internal thermal energy exchanger 78′″. The conditioned air then exits the internal thermal energy exchanger 78′″ and is selectively permitted by the blend door 34′″ to flow through the first passage 30′″ and/or the second passage 32′″ through the heater core 28′″ to be further heated to a desired temperature.

In other certain embodiments, when the fuel-powered engine of the vehicle is in operation and the HVAC system 10′″ is operating in the hot storage charge mode, the first fluid from the first fluid source 70′″ does not circulate through the conduit 72′″ to the evaporator core 24′″. However, the third fluid from the third fluid source 94′″ circulates through the respective conduits 96′″, 98 to the heater core 28′″ and the internal thermal energy exchanger 78′″. Additionally, the second fluid from the second fluid source 80′″ flows through the heat pipe 82′″ to the internal thermal energy exchanger 78′″. Specifically, a generally liquid-phase second fluid located in the end of the heat pipe 82′″ in thermal communication with the internal thermal energy exchanger 78′″ absorbs thermal energy from the air flowing through the air flow conduit 15′″ which has been heated by the third fluid from the third fluid source 94′″. As such, the generally liquid-phase second fluid evaporates into a generally vapor-phase second fluid. The generally vapor-phase second fluid then travels along the heat pipe 82′″ to the end of the heat pipe 82′″ in thermal communication with the second fluid source 80′″. Within the second fluid source 80′″, the generally vapor-phase second fluid releases thermal energy to heat or charge at least one of the phase change material, the coolant, and the phase change material coolant contained therein and condenses into the generally liquid-phase second fluid. The generally liquid-phase second fluid then returns through either capillary action or gravity to the end of the heat pipe 82′″ in thermal communication with the internal thermal energy exchanger 78′″ where the generally liquid-phase second fluid evaporates and repeats the cycle. In certain embodiments, the second fluid mixes with the third fluid before, in, or after flowing through the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the third fluid from the third fluid source 94′″ or a mixture of the second fluid and the third fluid to the air flowing through the internal thermal energy exchanger 78′″. The conditioned air then exits the internal thermal energy exchanger 78′″ and is selectively permitted by the blend door 34′″ to flow through the first passage 30′″ and/or the second passage 32′″ through the heater core 28′″ to be further heated to a desired temperature.

In other certain embodiments, when the fuel-powered engine of the vehicle is not in operation and the HVAC system 10′″ is operating in an engine-off heating mode, the first fluid from the first fluid source 70′″ does not circulate through the conduit 72′″ to the evaporator core 24′″. Additionally, the third fluid from the third fluid source 94′″ does not circulate through the respective conduits 96′″, 98 to the heater core 28′″ and the internal thermal energy exchanger 78′″. However, the second fluid from the second fluid source 80′″ flows through the heat pipe 82′″ to the internal thermal energy exchanger 78′″. Specifically, a generally vapor-phase second fluid located in the end of the heat pipe 82′″ in thermal communication with the internal thermal energy exchanger 78′″ releases thermal energy to the air flowing through the air flow conduit 15′″ and condenses into a generally liquid-phase second fluid. The generally liquid-phase second fluid then travels along the heat pipe 82′″ through either capillary action or gravity to the end of the heat pipe 82′″ in thermal communication with the second fluid source 80′″. Within the second fluid source 80′″, the generally liquid-phase second fluid absorbs thermal energy from at least one of the phase change material, the coolant, and the phase change material coolant and evaporates into the generally vapor-phase second fluid. The generally vapor-phase second fluid then returns to the end of the heat pipe 82′″ in thermal communication with the internal thermal energy exchanger 78′″ where the generally vapor-phase second fluid condenses and repeats the cycle. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the second fluid from the second fluid source 80′″ to the air flowing through the internal thermal energy exchanger 78′″. The conditioned air then exits the internal thermal energy exchanger 78′″ and is selectively permitted by the blend door 34′″ to flow through the first passage 30′″ and/or the second passage 32′″.

When the fuel-powered engine of the vehicle is in operation and the HVAC system 10′″ is in the recirculation heating mode or the hot storage charge mode, the first fluid from the first fluid source 70′″ does not circulate through the conduit 72′″ to the evaporator core 24′″. Additionally, the valves 97′″, 99 are closed to militate against the circulation of the third fluid from the third fluid source 94′″ through the respective conduits 96′″, 98 to the heater core 28′″ and the internal thermal energy exchanger 78′″. However, the second fluid from the second fluid source 80′″ flows through the heat pipe 82′″ to the internal thermal energy exchanger 78′″. Specifically, a generally liquid-phase second fluid located in the end of the heat pipe 82′″ in thermal communication with the internal thermal energy exchanger 78′″ absorbs thermal energy from the air flowing through the air flow conduit 15′″ and evaporates into a generally vapor-phase second fluid. The generally vapor-phase second fluid then travels along the heat pipe 82′″ to the end of the heat pipe 82′″ in thermal communication with the second fluid source 80′″. Within the second fluid source 80′″, the generally vapor-phase second fluid releases thermal energy to heat or charge at least one of the phase change material, the coolant, and the phase change material coolant contained therein. The transfer of thermal energy causes the generally vapor-phase second fluid to condense into the generally liquid-phase second fluid. The generally liquid-phase second fluid then returns through either capillary action or gravity to the end of the heat pipe 82′″ in thermal communication with the internal thermal energy exchanger 78′″ where the generally liquid-phase second fluid evaporates and repeats the cycle. Accordingly, a re-circulated air from a passenger compartment of the vehicle flow through the inlet section 16′″ and into the evaporator core 24′″ where a temperature of the air is relatively unaffected. The re-circulated air then flows from the evaporator core 24′″ to the internal thermal energy exchanger 78′″. As the air flows through the internal thermal energy exchanger 78′″, the re-circulated air transfers thermal energy to the second fluid. The transfer of thermal energy from the re-circulated air to the second fluid heats the second fluid. The second fluid then flows to the second fluid source 80′″ and releases thermal energy to heat or charge the phase change material, the coolant, the phase change material coolant, or any combination thereof contained in the second fluid source 80′″. The re-circulated air then exits the internal thermal energy exchanger 78′″ and is selectively permitted by the blend door 34′″ to flow through the first passage 30′″ and/or the second passage 32′″. It is understood, however, that in other embodiments the valve 97′″ is open, permitting the third fluid from the third fluid source 94′″ to circulate through the conduit 96′″ to the heater core 28′″ and heat the re-circulated air flowing through the second passage 32′″ to a desired temperature.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heating, ventilating, and air conditioning (HVAC) system, comprising:
a control module including housing having an air flow conduit formed therein;
an evaporator core disposed in the air flow conduit, at least a portion of the evaporator core configured to receive a first fluid from a first fluid source therein; and
a thermal energy exchanger disposed in the air flow conduit downstream of the at least a portion the evaporator core, the thermal energy exchanger in thermal energy exchange relationship with a second fluid source through a heat pipe.

2. The HVAC system of claim 1, wherein the thermal energy exchanger is one of another portion of the evaporator core and separate from the evaporator core.

3. The HVAC system of claim 1, further comprising a heater core disposed in the air flow conduit, wherein the heater core is in fluid communication with a third fluid source.

4. The HVAC system of claim 3, wherein the thermal energy exchanger is in fluid communication with the third fluid source.

5. The HVAC system of claim 1, wherein the first fluid source is a refrigeration circuit.

6. The HVAC system of claim 1, wherein the second fluid source is one of an external thermal energy exchanger and a fluid reservoir containing at least one of a phase change material, a coolant, and a phase change material coolant.

7. A heating, ventilating, and air conditioning (HVAC) system, comprising:
a control module including housing having an air flow conduit formed therein; and
an evaporator core having a plurality of layers disposed in the air flow conduit, wherein at least one of the layers is configured to receive a first fluid from a first fluid source therein and at least another one of the layers is in thermal energy exchange relationship with a second fluid source through a heat pipe, wherein the heat pipe is configured to receive a second fluid from the second fluid source therein.

8. The HVAC system of claim 7, further comprising a heater core disposed in the air flow conduit, wherein the heater core is in fluid communication with a third fluid source.

9. The HVAC system of claim 8, wherein the at least another one of the layers of the evaporator core is in fluid communication with the third fluid source.

10. The HVAC system of claim 7, wherein the first fluid and the second fluid are different fluid types.

11. The HVAC system of claim 7, wherein the first fluid is a refrigerant and the second fluid is at least one of a phase change material, a coolant, and a phase change material coolant.

12. The HVAC system of claim 7, wherein the first fluid source is a refrigeration circuit.

13. The HVAC system of claim 7, wherein the second fluid source is one of an external thermal energy exchanger and a fluid reservoir containing at least one of a phase change material, a coolant, and a phase change material coolant.

14. The HVAC system of claim 7, wherein the at least another one of the layers of the evaporator core is disposed downstream from the at least one layer of the evaporator core configured to receive the first fluid therein.

15. The HVAC system of claim 7, wherein the at least another one of the layers of the evaporator core is disposed between a plurality of the layers of the evaporator core configured to receive the first fluid therein.

16. The HVAC system of claim 7, wherein the least another one of the layers of the evaporator core is disposed downstream of and spaced apart from the at least one layer of the evaporator core configured to receive the first fluid therein.

17. A heating, ventilating, and air conditioning (HVAC) system of a vehicle, comprising:
a control module including a housing having an air flow conduit formed therein;
an evaporator core disposed in the air flow conduit, at least a portion of the evaporator core configured to receive a first fluid from a first fluid source therein;
a thermal energy exchanger disposed in the air flow conduit downstream of the at least a portion the evaporator core, the thermal energy exchanger in fluid communication with a second fluid source through a heat pipe configured to receive a second fluid from the second fluid source therein; and
a heater core disposed in the air flow conduit downstream of the thermal energy exchanger, the heater core in fluid communication with a third fluid source.

18. The HVAC system of claim 17, wherein the thermal energy exchanger is in fluid communication with the third fluid source.

19. The HVAC system of claim 17, wherein the third fluid source is a fuel-powered engine of the vehicle.

20. The HVAC system of claim 17, wherein the first fluid and the second fluid are different fluid types.
